(19) United States
(12) Patent Application Publication
(10) Pub. No.: US 2013/0238827 A1
(43) Pub. Date: Sep. 12, 2013

(54) Motherboard having an attached expansion card with both PCI slot and PCIe slot

(71) Applicant: Heng-Sheng Lin, New Taipei (TW)

(72) Inventor: Heng-Sheng Lin, New Taipei (TW)

(21) Appl. No.: 13/417,330

(22) Filed: Mar. 12, 2012

(51) Int. Cl. G06F 13/00

(52) U.S. Cl. 710/301

(57) ABSTRACT

A computer motherboard is provided with a plurality of expansion slots; an expansion card including a PCB, a PCI slot disposed on the PCB, two connectors disposed on an edge of the PCB, each connector including a plurality of contacts, and a PCIe slot disposed on the PCB wherein both the PCI slot and the PCIe slot are electrically connected to the contacts; a PCI card fitted into the PCI slot; and a PCIe card fitted into the PCIe slot. The computer mother can be made compact.

### BACKGROUND OF THE INVENTION

1. Field of the Invention

The invention relates to computer motherboard and more particularly to a motherboard having two expansion slots adapted to hold an inserted expansion card in place, the expansion card having both PCI slot and PCIe slot adapted to hold inserted PCI card and PCIe card in place respectively.

2. Description of Related Art

The primary purpose of an expansion card is to provide or expand on features not offered by a computer motherboard. For example, original IBM PC did not provide graphics capability. In that case, a graphics card provided graphics capability can be attached to the motherboard.

Edge connectors are commonly used in personal computers for connecting expansion cards and computer memory to the system bus. Example expansion peripheral technologies which use edge connectors include PCI (Peripheral Component Interconnect) and PCI Express (abbreviated as PCIe).

However, a motherboard is required to have both a PCI slot and a PCIe slot so that a PCI card may fit into the PCI slot and a PCIe card may fit into the PCIe slot respectively. This inevitably can reduce available area of the motherboard and in turn it can reduce the expansibility of the motherboard. This is not desired because features including lightweight and compactness are always sought by the computer industry. Thus, the need for improvement still exists.

### SUMMARY OF THE INVENTION

It is therefore one object of the invention to provide a computer motherboard comprising a plurality of expansion slots; an expansion card including a PCB (printed circuit board), a PCI (Peripheral Component Interconnect) slot disposed on the PCB, two connectors disposed on an edge of the PCB, each connector including a plurality of contacts, and a PCIe (Peripheral Component Interconnect Express) slot disposed on the PCB wherein both the PCI slot and the PCIe slot are electrically connected to the contacts; a PCI card fitted into the PCI slot; and a PCIe card fitted into the PCIe slot.

The above and other objects, features and advantages of the invention will become apparent from the following detailed description taken with the accompanying drawings.

### BRIEF DESCRIPTION OF THE DRAWINGS

FIG. 1 is a perspective view of a computer motherboard having an attached expansion card according to the invention;

FIG. 2 is a perspective view of the expansion card having both a PCI slot and a PCIe slot; and

FIG. 3 is a view similar to FIG. 1 showing the expansion card of FIG. 2 being attached to the computer motherboard.

### DETAILED DESCRIPTION OF THE INVENTION

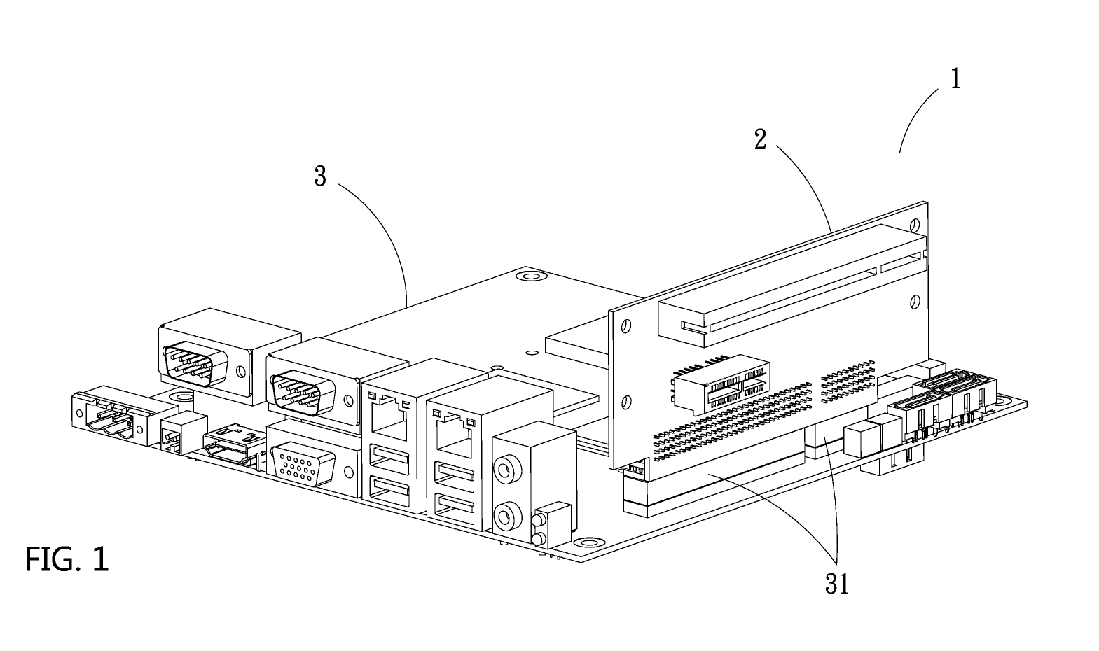

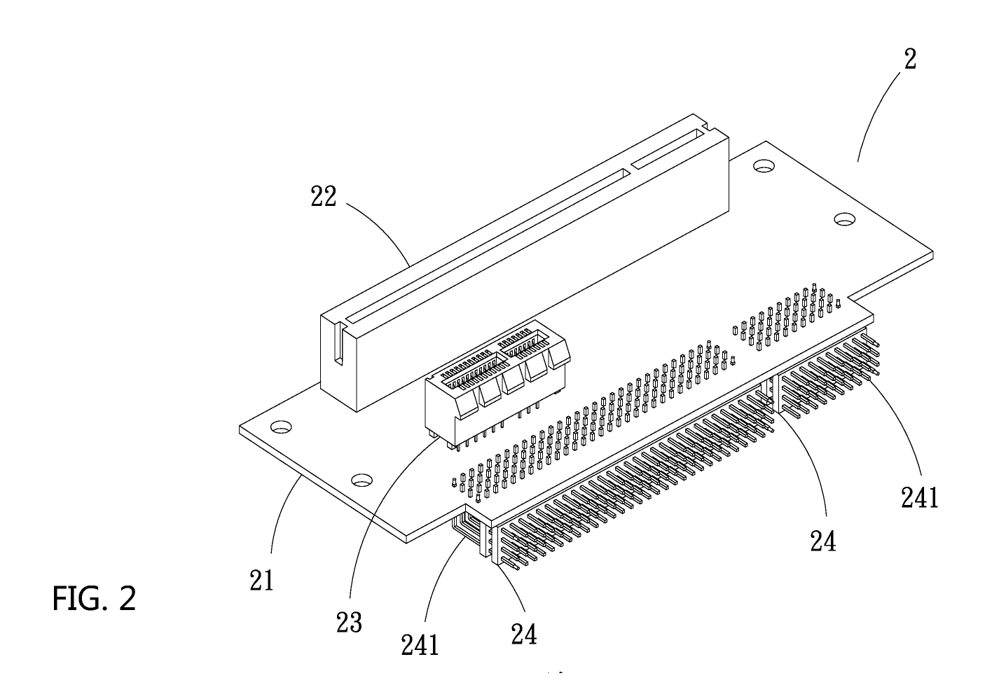

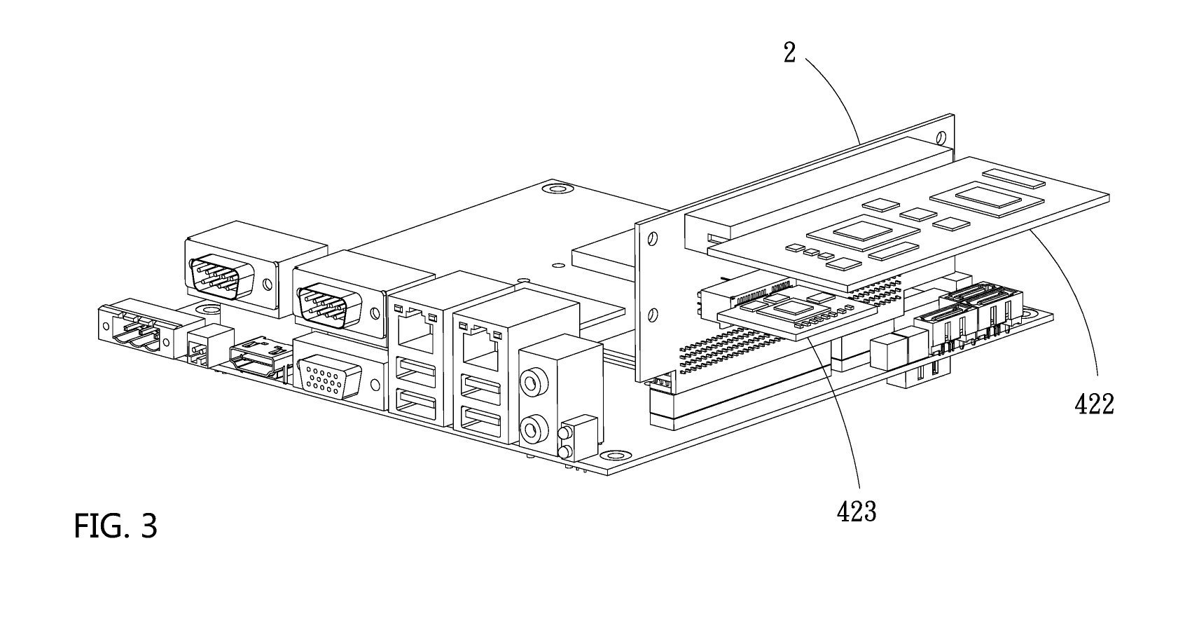

Referring to FIGS. 1 to 3, a computer motherboard 1 in accordance with the invention comprises the following components as discussed in detail below.

Two expansion slots 31 are provided on the motherboard 1. An expansion card 2 comprises a printed circuit board (PCB) 21, a PCI slot 22 provided along one edge of the PCB 21, two connectors 24 provided on the opposite other edge of the PCB 21, each connector 24 having a plurality of contacts (i.e., pins) 241 shaped as an L, and a PCIe slot 23 provided between the PCI slot 22 and the connectors 24. Both the PCI slot 22 and the PCIe slot 23 are electrically connected to the pins 241.

The computer motherboard 1 comprises two expansion slots 31 provided adjacent to one edge. A PCI card 422 and a PCIe card 423 are fitted into the PCI slot 22 and the PCIe slot 23 respectively. The pins 241 of both connectors 24 are inserted into the expansion slots 31 respectively.

It is envisaged by the invention that a compact computer motherboard having such attached expansion card with both PCI slot and PCIe slot can be carried out.

While the invention has been described in terms of preferred embodiments, those skilled in the art will recognize that the invention can be practiced with modifications within the spirit and scope of the appended claims.

What is claimed is:

1. A computer motherboard comprising:
a plurality of expansion slots;
an expansion card including a PCB (printed circuit board), a PCI (Peripheral Component Interconnect) slot disposed on the PCB, two connectors disposed on an edge of the PCB, each connector including a plurality of contacts, and a PCIe (Peripheral Component Interconnect Express) slot disposed on the PCB wherein both the PCI slot and the PCIe slot are electrically connected to the contacts;
a PCI card fitted into the PCI slot; and
a PCIe card fitted into the PCIe slot.
